(19) United States
(12) Patent Application Publication
(10) Pub. No.: US 2011/0146351 A1
(43) Pub. Date: Jun. 23, 2011

(54) METHOD AND APPARATUS FOR DIRECTLY FORMING CONTINUOUS GLASS FILAMENTS

(76) Inventors: Todd M. Harms, Granville, OH (US); Byron L. Bemis, Newark, OH (US)

(21) Appl. No.: 12/646,470

(22) Filed: Dec. 23, 2009

(51) Int. Cl. C03B 37/085

(52) U.S. Cl. 65/495

(57) ABSTRACT

An in-line system converts raw, unrefined glass-forming material directly into continuous glass filaments. The system includes a reinforced melting assembly with electrically conductive melting and reinforcing members. The melting and reinforcing members are connected to a transverse melting member and lie in a plane parallel to the flowing material. This expands the melting and refining zone to the height of the melting and reinforcing members, thereby improving the quality of the filaments. The melting and reinforcing members also prevent sagging of the assembly during high temperature operation. The outermost melting and reinforcing members reduce or eliminate bypass flow of un-refined or un-homogenized material around the melting assembly, further improving quality.

### TECHNICAL FIELD AND INDUSTRIAL APPLICABILITY OF THE INVENTION

The present invention relates generally to an apparatus for processing mineral materials to form continuous fibers, and more particularly, to an in-line system for processing of raw glass batch compositions directly into continuous glass filaments.

### BACKGROUND OF THE INVENTION

Industry takes three main approaches to glass melting for making continuous filaments: (1) indirect melt (also called marble re-melt); (2) direct melt using larger-scale furnaces; and (3) direct melt using smaller-scale furnaces, sometimes referred to as paramelters.

For indirect marble re-melt, molten glass is sheared and rolled into marbles roughly 0.62 inch (15 to 16 mm) in diameter. The marbles are cooled, packaged and then transported to a fiber manufacturing facility where they are re-melted for fiberization. The marbles facilitate visual inspection of the glass for impurities, resulting in a more consistent product. One marble re-melt method involves the steps of melting raw glass-forming materials—referred to as glass batch—in a comparatively large furnace, refining the glass in a refining chamber, and forming the glass into spherical bodies or marbles. To produce fibers, the glass marbles are electrically heated to re-melt the glass to a viscosity at which streams of the glass are flowed through orifices in a bushing and then attenuated into filaments by winding a strand of the filaments on a rotating collector. This method is costly as it involves special apparatus for handling and feeding the glass marbles and requires large amounts of electric energy in re-melting the marbles.

Direct melt processes, in contrast, process raw, glass-forming materials into molten or heat-softened glass in a furnace which is then sent directly to fiber-forming equipment. Direct melt processes eliminate the intermediate steps and the cost of forming marbles. The fining and refining steps, performed to remove un-dissolved materials and thermally condition the molten or heat-softened glass, however, cannot be eliminated and must be integrated into the process.

In large scale direct melt processes glass batch is reduced to a molten or heat-softened state and refined in a furnace. The molten glass then flows horizontally through a forehearth channel to comparatively shallow stream feeders or bushings disposed along the forehearth. Streams of glass delivered through orifices in the feeders or bushings are attenuated to filaments by winding strands of the filaments on a rotating collector. In the direct melt process as the glass is melted and refined by the application of heat, the temperature of the molten glass is brought to a temperature that is comparatively high in order to effect refining of the glass. During this process of melting and refining the glass, the molten or heat softened glass at a high temperature in the furnace emits gases and volatiles, and seeds in the glass are dissolved. If the molten glass is increased in temperature above the maximum melt temperature, the higher temperatures promotes further emission of gases and volatiles, a condition referred to as “reboiling.” Hence the higher the temperature of the melt in the furnace, the more gases and volatiles that are driven off. This action of melting and refining the glass at elevated temperatures renders the glass substantially stable for any temperature less than the maximum melt temperature in the furnace. Controlled heat treatment of the glass in stream feeder or bushing of substantial depth for a period of time reconditions and homogenizes the glass as well as stabilizing the temperature in each bushing.

Smaller scale direct melt processes are characterized by in-line, vertical material flows that occur in a system sometimes referred to as a paramelter. One common design uses a curved, sheet-like, metal current-conducting heater element disposed across a melting chamber. See, for example, U.S. Pat. Nos. 3,264,076 to Veazie et al., 4,262,158 to Lynch and 6,810,693 to Hartman et al. When high amperage electrical current passes through the sheet-like heating element, the heat from the energized element continuously converts input mineral material into molten or heat-softened glass. The heating element is generally oriented transversely, across the direction of flow of the molten or heat-softened material.

As shown in FIGS. 1 and 2, an electric current conducting member in the form of a perforated strip 100 is fashioned of an alloy of platinum and rhodium, adapted to conduct current through the material to reduce the glass batch to a heat-softened state. Perforations or openings 102 in strip 100 allow material reduced to a molten or heat-softened condition above strip 100 to flow into the region of the chamber 98 beneath strip 100. The current conducting terminals for strip 100 are at the sides of the furnace. Each side edge of strip 100 indicated at 104 is in electrically conducing contact with terminals which are adapted to be connected with a source of electric energy such as a power transformer through conductors for supplying the electric energy to strip 100. Strip 100 is preferably of catenary configuration or shape for supporting the heat-softened material and batch above strip 100.

Electric current is supplied to the heater strip 100 under controlled conditions to regulate and coordinate the rate of melting of the batch material 87 with the rate of delivery of streams of continuous fibers or filaments 170. The melting zone or region is existent slightly above and below the heater strip 100. The melt is maintained in the chamber 98 at comparatively high temperatures and for a period of time to effect refining and substantially complete homogenization of the glass. Such time-temperature treatment reduces crystallization and thereby promotes the formation of extremely high strength fibers or filaments.

As noted in U.S. Pat. No. 3,264,076 to Veazie et al., a thorough and complete homogenization of such materials at high temperature is essential. It has been difficult, however, to attain a homogenized melt satisfactory for use in forming filaments.

### SUMMARY OF THE INVENTION

It is an object of the present invention to provide a reinforced melting assembly that increases the amount of heat provided to convert raw, glass-forming material into a fined and refined, molten or heat-softened material suitable for drawing into continuous filaments.

It is also an object of the present invention to provide a reinforced melting assembly that produces a larger heating zone, thereby transferring heat from the reinforced melting assembly to raw, glass-forming material more efficiently.

It is a further object of the present invention to reduce or eliminate bypass flow of un-reacted or un-homogenized material.

It is another object of the present invention to provide a system for directly converting raw, unrefined glass forming materials into continuous filaments wherein the melting assembly and the bushing through which the filaments are drawn may be operated at different temperatures.

It is an advantage of the present invention that the inventive reinforced melting assembly has an increased surface area compared to conventional melting assemblies.

It is further an advantage of the present invention that the inventive reinforced melting assembly is less prone to sagging after extended operation.

In one aspect, the present invention comprises an improved reinforced melting assembly for use in an in-line, direct melt system for producing continuous glass filaments directly from unrefined, raw glass-forming materials.

The reinforced melting assembly includes an electrically conductive, transverse melting member. In use the transverse melting member is disposed transverse to the flow direction of the glass-forming materials upstream of a bushing. The transverse melting member has perforations there through, and has opposed longitudinal flanges adapted for connection to a power supply.

The reinforced melting assembly also includes a plurality of electrically conductive, melting and reinforcement members that extend across the width of the transverse melting member at spaced intervals between the flanges. Each melting and reinforcement member lies in a plane parallel to the material flow direction. The melting and reinforcing members are connected both electrically and physically to the upstream surface of the transverse melting member.

In another aspect, the present invention is an in-line direct melt system for converting raw, unrefined glass batch directly into continuous filaments. The direct melt system includes a furnace having opposed end walls, opposed side walls longer than said end walls, and an inlet for receiving said raw glass-forming material. The direct melt system also includes an electrically conductive bushing having a plurality of outlets for discharging continuous glass filaments. A first power supply is electrically connected to the bushing for heating the bushing to a first temperature. The direct melt system further includes a reinforced melting assembly that is disposed transverse to the material flow direction upstream of the bushing. The reinforced melting assembly includes an electrically conductive, transverse melting member having perforations there through and having opposed longitudinal flanges adapted for connection to a second power supply along the side walls. The second power supply is separate from the first power supply for heating the reinforced melting assembly to a second temperature. Electrically conductive, melting and reinforcement members extend across the width of the upstream surface of the transverse melting member at spaced intervals. Each melting and reinforcement member lies in a plane parallel to the material flow direction and is electrically and physically connected to the transverse melting member.

The electrically conductive melting and reinforcing members of the present invention substantially increase the size of the melting and refining zone by extending the melting and refining zone up to the height of the melting and reinforcing members, thereby improving the quality of glass and filaments produced there from. The melting and reinforcing members also stiffen the melting assembly, and reduce sagging of the assembly during extended operation at high temperatures. The outermost melting and reinforcing members may be disposed along the edges of the transverse melting member, thereby reducing or eliminating bypass flow of unrefined or un-homogenized material around the reinforced melting assembly.

In still another aspect, the present invention is an in-line method for producing continuous glass filaments directly from glass batch. The batch defines a flow direction. In the method glass batch is supplied to a furnace. A reinforced melting assembly is provided in the furnace and is disposed transverse to the flow direction upstream of a bushing. The reinforced melting assembly includes an electrically conductive, transverse melting member disposed transverse to the flow direction upstream of a bushing. The transverse melting member has perforations for flow there through and has opposed longitudinal flanges adapted for connection to a power supply. The reinforced melting assembly also includes electrically conductive, melting and reinforcement members extending across the width of an upstream surface of the transverse melting member at spaced intervals. Each melting and reinforcement member is provided in a plane parallel to the flow direction. The melting and reinforcing members are electrically and physically connected to the transverse melting member. The method further includes forming a melting and refining zone that extends up to a height of the melting and reinforcement members by electrically heating the transverse melting member and the melting and reinforcement members. The glass batch is converted into a heat-softened material in the melting and refining zone, and the heat-softened material is formed into continuous glass filaments by drawing the heat-softened material through openings in the bushing. The bushing may be heated to a first temperature by electrically connecting the bushing to a first power supply, and the reinforced melting assembly may be heated to a second temperature by electrically connecting the reinforced melting assembly to a second power supply electrically separate from the first power supply. Bypass flow of material around the reinforced melting assembly may be reduced by providing melting and reinforcing members along the ends of the transverse melting member. The transverse melting member may be formed by bending one or more sheets to form a base plate connected between longitudinal flanges by diverging sidewalls.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a longitudinal sectional view of a known apparatus for processing glass batch into continuous filaments;

FIG. 2 is a transverse sectional view taken substantially along line 2-2 of FIG. 1;

FIG. 3 is partially schematic sectional view of the present invention in its operating environment.

FIG. 4 is a perspective view of a reinforced melting assembly according to an exemplary embodiment of the present invention;

FIG. 5 is a top view of a reinforced melting assembly according to an exemplary embodiment of the present invention;

FIG. 6 is a side view of the reinforced melting assembly of FIG. 5, taken along line 6-6;

FIG. 7 is a top view of a transverse melting member suitable for use in the present invention;

FIG. 8 is a side view of a transverse melting member suitable for use in the present invention;

FIG. 9 is a side view of a melting and reinforcement member suitable for use in the present invention;

FIG. 10 is a side view of an outer melting and reinforcement member suitable for use in the present invention;

FIG. 11 is a side view of a lower reinforcement member suitable for use in the present invention.

### DETAILED DESCRIPTION AND PREFERRED EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless defined otherwise, all technical and scientific terms used herein have the same meaning as commonly understood by one of ordinary skill in the art to which the invention belongs. The terminology used in the description of the invention herein is for describing particular embodiments only and is not intended to be limiting of the invention. Although any methods and materials similar or equivalent to those described herein can be used in the practice or testing of the present invention, the preferred methods and materials are described herein. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. Like numbers found throughout the figures denote like elements.

The present invention is an improved, reinforced melting assembly 10 for use in an in-line, direct-melt furnace for the production of continuous glass filaments directly from raw, glass-forming materials, such as the batch-to-fiber forming systems described in U.S. Pat. Nos. 3,264,076, and 4,262,158 and 6,810,693.

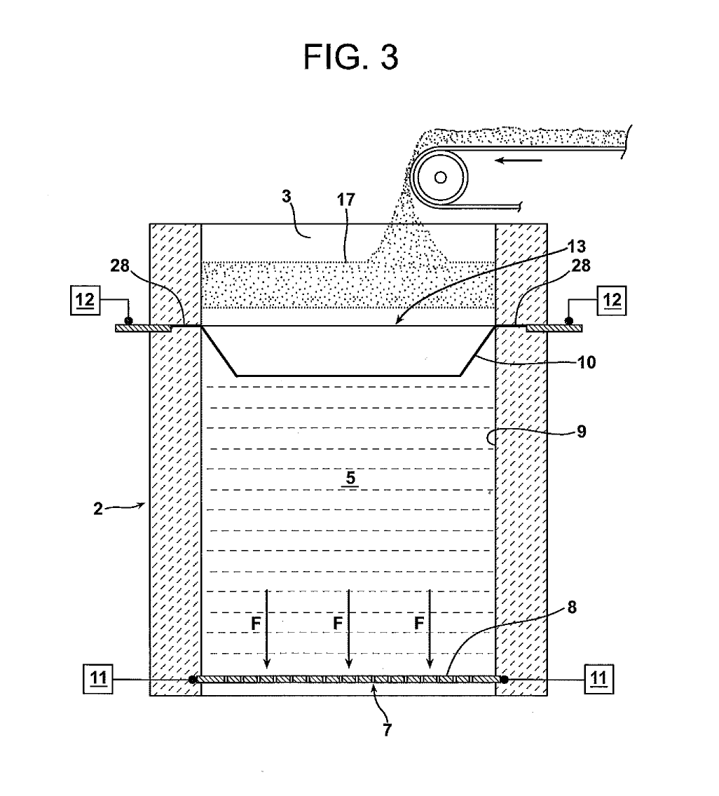

As shown in FIG. 3, in operation raw, glass-forming materials 17 are fed in comminuted form into furnace 2 formed by end walls 5 and sidewalls 9 through inlet port 3 to electrically conductive, reinforced melting assembly 10.

Reinforced melting assembly 10 provides heat to the raw, glass-forming material by electrical resistance (Joule) heating, thereby forming a melting and refining zone 13 in which the raw, glass-forming material 17 is converted into a fined and refined, molten or heat-softened material suitable for drawing into continuous filaments through outlets or orifices 7 in electrically conducting bushing 8. The glass-forming and molten or heat-softened material flows vertically downward defining a flow direction F.

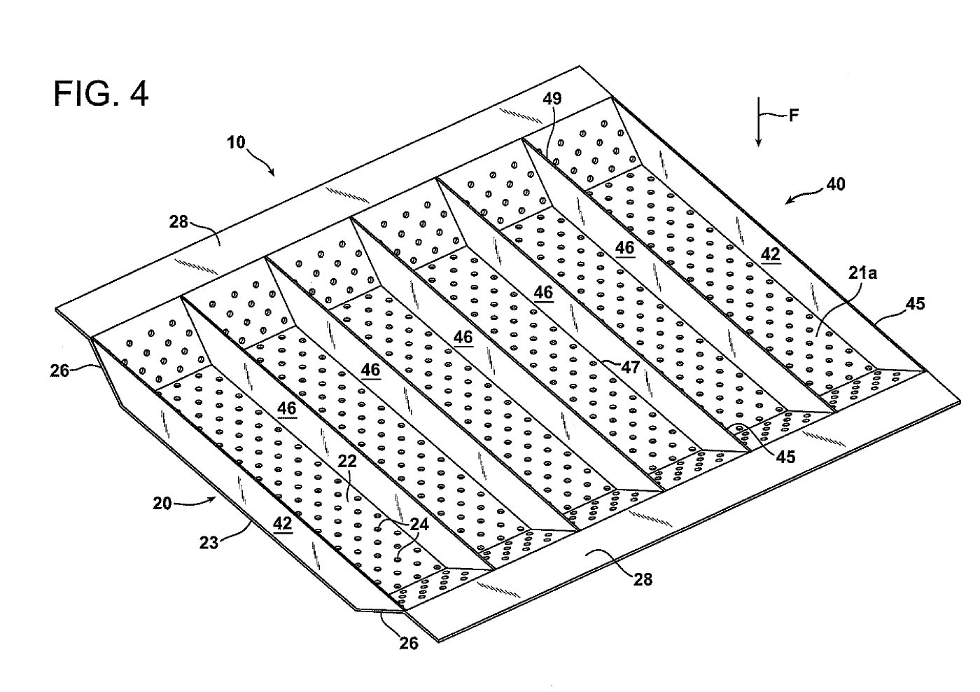

As shown in FIG. 4, an exemplary reinforced melting assembly 10 includes a transverse melting member 20 disposed between longitudinal flanges 28. In operation transverse melting member 20 spans the flow area of the raw, glass-forming material transverse to flow direction F. Transverse melting member 20 includes a regular pattern of holes or perforations 24 that permit the molten or heat-softened material to flow there through.

In operation, the fined and refined, molten or heat-softened material passes through the perforations 24 of transverse melting member 20 to bushing 8 having a plurality of outlets 7 for discharging the molten or heat-softened material as continuous filaments.

As shown in FIG. 3, electrically conductive bushing 8 is connected to a first power supply 11.

Reinforced melting assembly 10 may be made of a precious metal, including precious metal alloys such as platinum-rhodium alloys, e.g. 80% platinum-20% rhodium by weight, and is electrically connected to a second power supply 12 by opposed longitudinal flanges 28.

First power supply 11 is separate from second power supply 12, making it possible to independently control the temperatures of reinforced melting assembly 10 and electrically conductive bushing 8. This permits reinforced melting assembly 10 to operate at a higher temperature than electrically conductive bushing 8. By way of example, reinforced melting assembly 10 may be operated at a temperature about 400 degrees F. higher than the temperature of electrically conductive bushing 8. As a further example, the reinforced melting assembly 10 may be operated at a temperature of about 3050 degrees F., while electrically conductive bushing 8 may be operated at a temperature of about 2650 degrees F.

As shown in FIG. 4, reinforced melting assembly 10 includes electrically conductive, melting and reinforcing members 40. Melting and reinforcing members 40 extend across the width of transverse melting member 20 at spaced intervals between longitudinal flanges 28. Each melting and reinforcing member 40 lies in a plane parallel to flow direction F, and is electrically and physically connected, for example by welding, to the upstream surface 21a of transverse melting member 20.

Melting and reinforcing members 40 advantageously carry current in operation, along with transverse melting member 20, thereby providing additional heat needed to process the raw, glass-forming material into a fined and refined, molten or heat-softened material suitable for drawing into continuous filaments. Melting and reinforcing members 40 carry current from side-to-side, across the width of reinforced melting assembly 10, and are thus aligned with the current flow across reinforced melting assembly 10.

Melting and reinforcing members 40 also advantageously serve to structurally stiffen reinforced melting assembly 10, thereby preventing sagging of the assembly during extended operation at high temperatures.

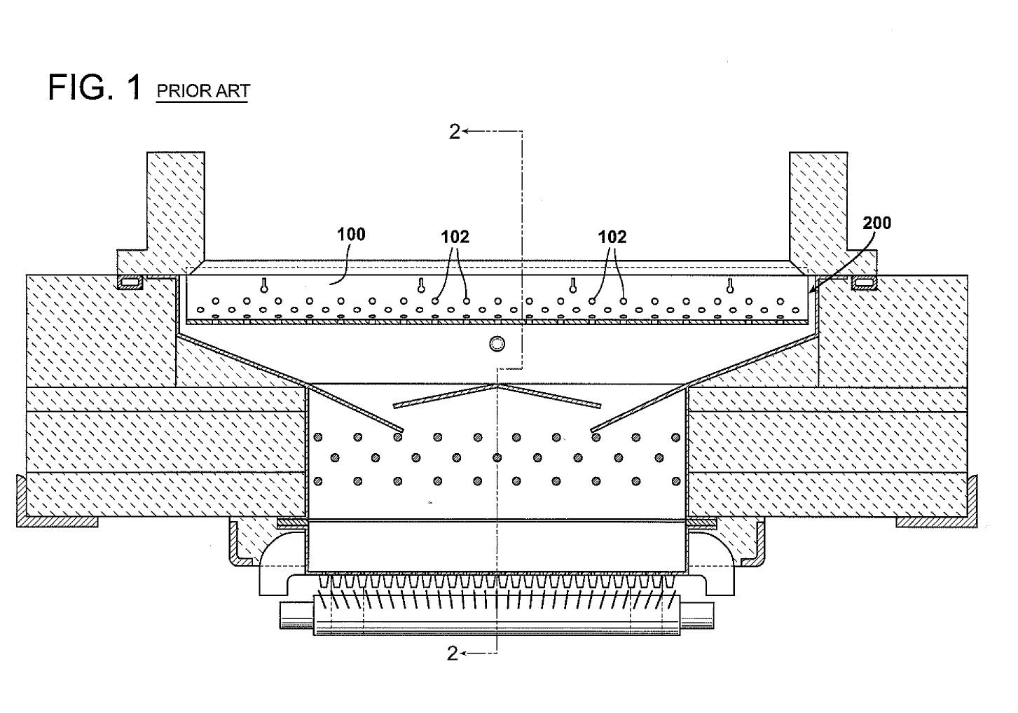

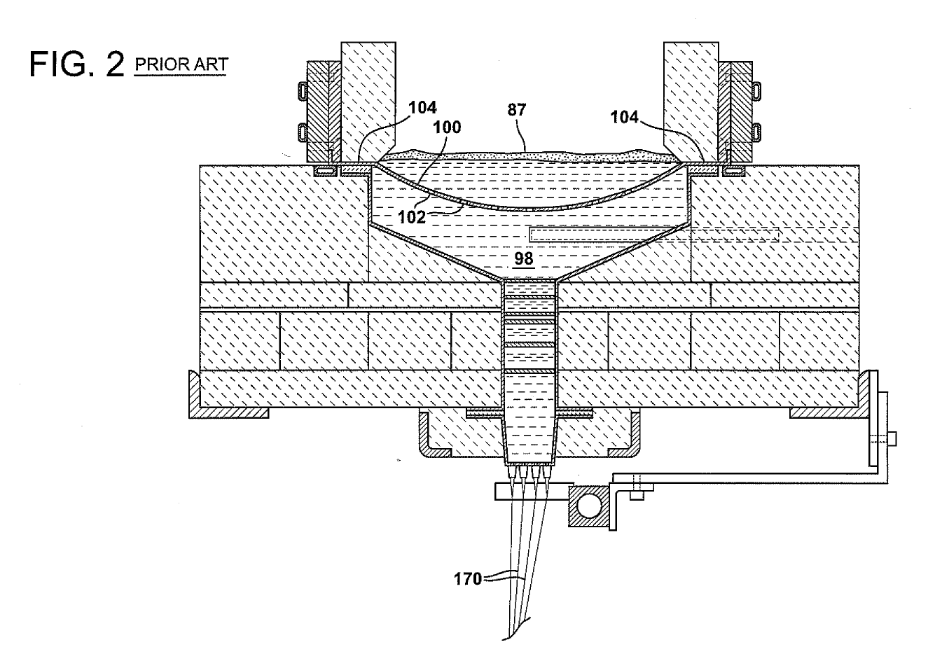

As can be seen in FIG. 1, existing arrangements create a gap 200 along the entire width of the current-conducting heater element 100. Gap 200 undesirably permits a surprisingly large amount of un-reacted, un-homogenized glass-forming material to bypass around element 100 thereby degrading the quality of the glass and the fibers formed there from. As shown in FIG. 4, melting and reinforcing members 40 may include inner melting and reinforcing members 46 and outermost melting and reinforcing members 42. Outermost melting and reinforcing members 42 are placed along the ends 23 of transverse melting member 20, thereby reducing or eliminating bypass flow across the ends of transverse melting member 20. Outermost melting and reinforcing members 42 therefore advantageously direct the majority of the flow through the holes or perforations 24 in transverse melting member 20, thus providing better flow control. This improved flow control greatly increases minimum residence time in the system.

Transverse melting member 20 and melting and reinforcing members 40 may advantageously have a trapezoidal profile for ease of manufacture, but may have other shapes, including a catenary profile.

In an exemplary embodiment shown in FIG. 4, transverse melting member 20 includes a generally planar, base plate 22. Base plate 22 is connected between longitudinal flanges 28 by diverging sidewalls 26. Base plate 22 and diverging sidewalls 26 are provided with a uniform pattern of holes or perforations 24.

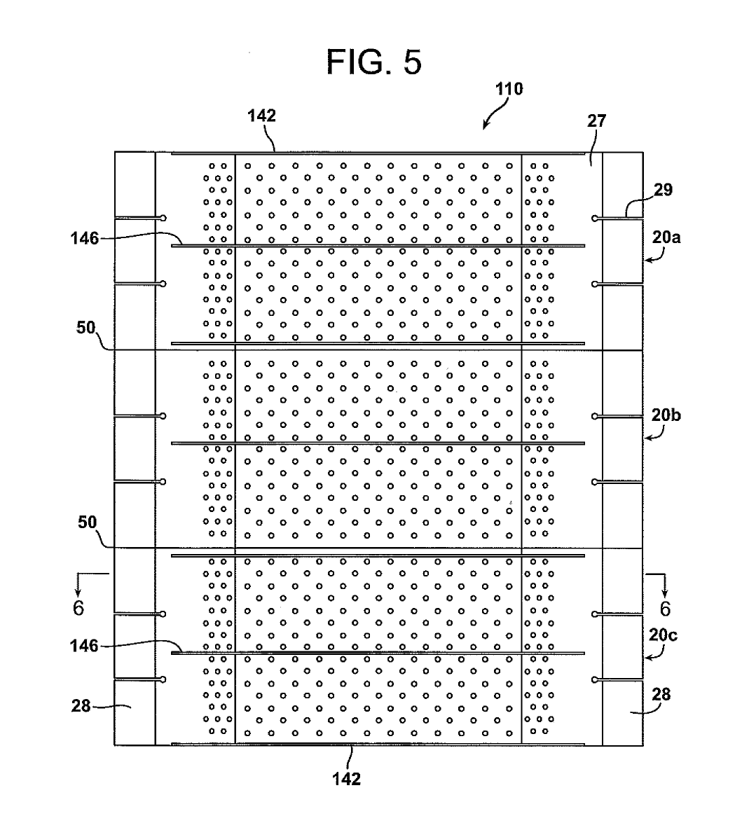

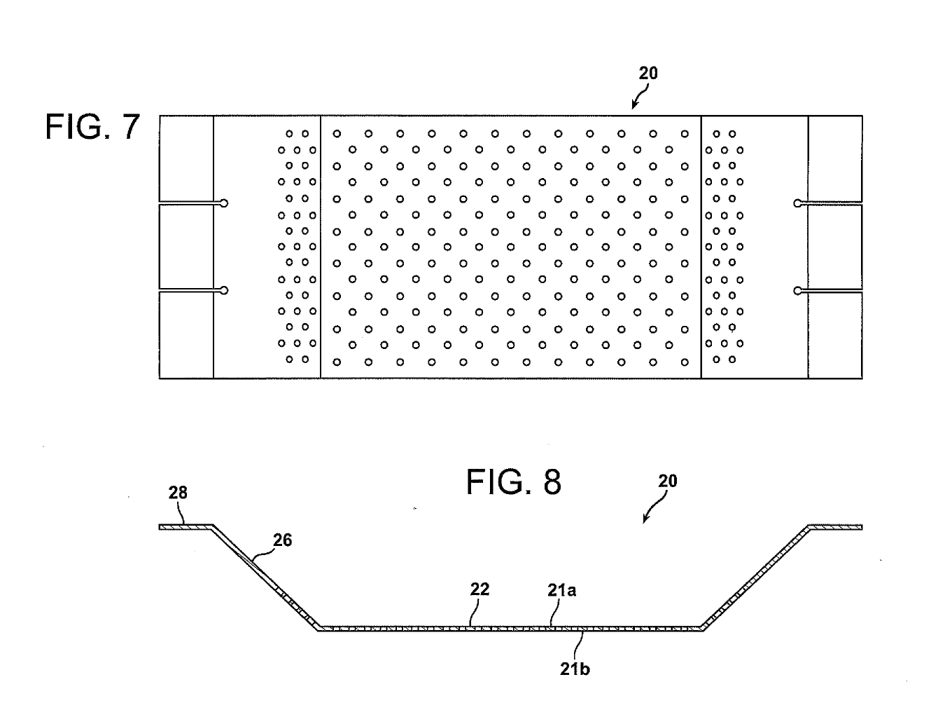

Base plate 22 and diverging sidewalls 26 combine to form a transverse melting member 20 with an upstream surface 21a having a trapezoidal shape, and may be formed by bending the single integral sheet shown in FIG. 7, or by bending one or more sheets 20a-20c that have been joined together prior to bending, for example by welds 50, as shown in FIG. 5.

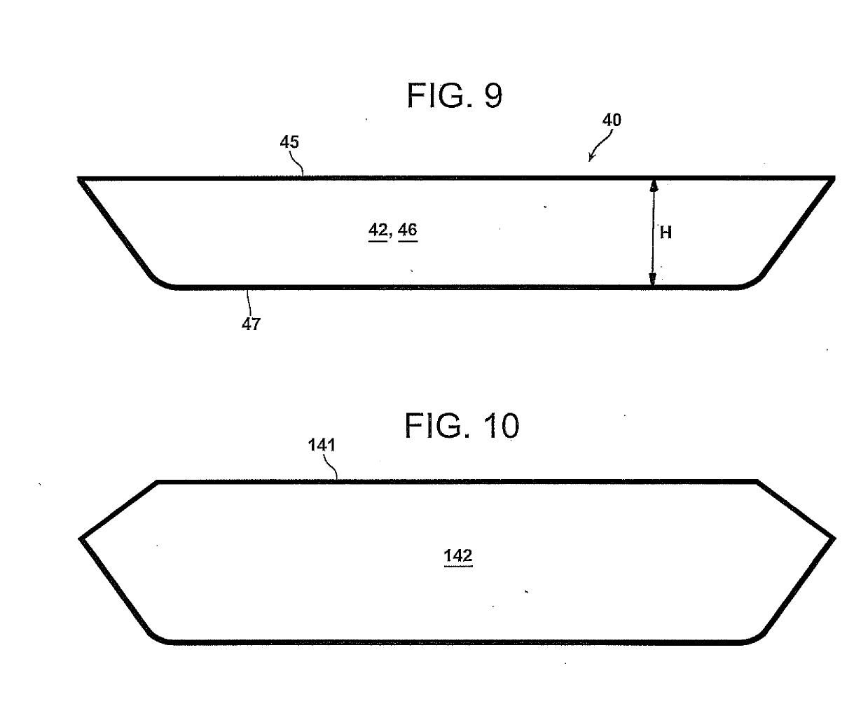

As shown in FIGS. 4 and 9, melting and reinforcing members 40 may have a generally trapezoidal shape that includes a lower surface 47, adapted to contact the upstream surface 21a of transverse melting member 20 to which it is joined physically and electrically, for example by welding.

Melting and reinforcing members 40 advantageously extend the melting and refining zone 13 up to the height H of the melting and reinforcing members 40, compared to a height of only about ¼-½ inch adjacent the un-reinforced catenary melting member of the prior art. Reinforced melting assembly 10 thus advantageously provides a larger melting and refining zone compared to prior designs, thereby transferring heat from the reinforced melting assembly 10 to raw, glass-forming material more efficiently and improving the quality of glass and filaments produced there from.

As shown in FIG. 4, melting and reinforcing members 40 may include an upper surface 45 that lies level with longitudinal flanges 28.

Referring now to FIGS. 5, 6 and 10, in an alternate embodiment, reinforced melting assembly 110 may include outer melting and reinforcement members 142 with an upper edge 141 that lies above longitudinal flanges 28. This advantageously provides an additional barrier to bypass flow by un-refined or un-homogenized material. As best seen in FIG. 10, outer melting and reinforcement members 142 may have a six-sided profile generally in the form of two trapezoidal members joined along their longest sides.

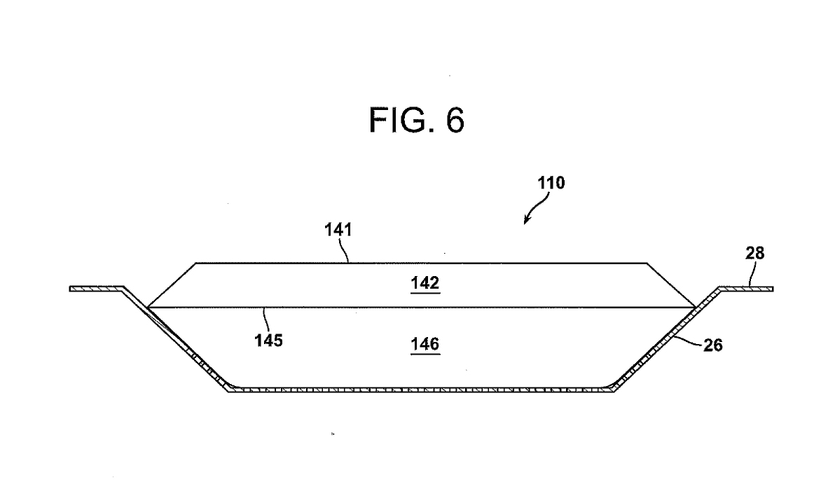

As shown in FIG. 6, reinforced melting assembly 110 may also include inner melting and reinforcing members 146 with an upper edge 145 that lies below longitudinal flanges 28.

As shown in FIG. 5, reinforced melting assembly 110 may further include crumple zones 27, located on outwardly diverging sidewalls 26 adjacent longitudinal flanges 28. Crumple zones 27 are typically free of holes or perforations. In this arrangement melting and reinforcement members 142, 146 serve to stiffen reinforced melting assembly 10, while crumple zones 27 are free of reinforcement. In operation crumple zone 27 is thus free to deform, for example by bending or becoming wavy, thereby allowing reinforced melting assembly 10 to deform in a controlled manner. Reinforced melting assembly 110 may further include a plurality of keyhole slots 29 that extend transversely across longitudinal flanges 28 to crumple zones 27.

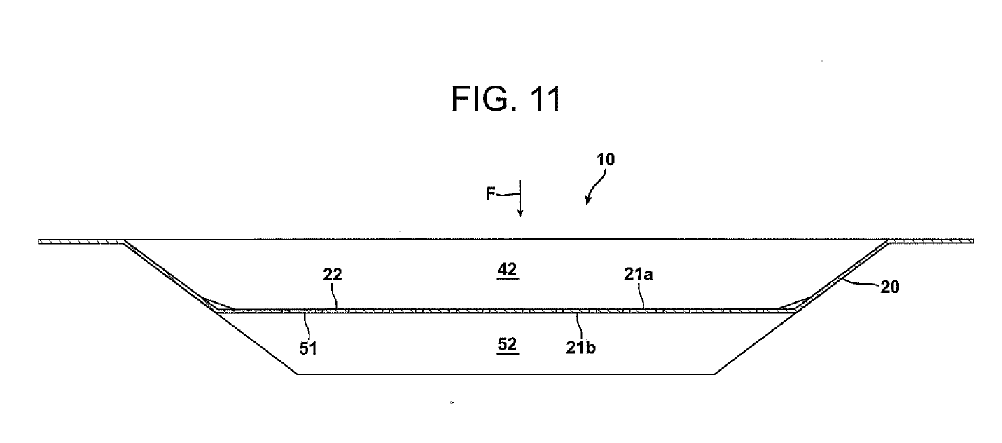

As shown in FIG. 11, reinforced melting assembly 10 may include one or more lower reinforcing members 52 located below transverse melting member 20. Each lower reinforcing member 52 extends across the width of perforated base plate 22 along a downstream surface 21b at spaced intervals. Each lower reinforcing member 52 lies in a plane parallel to flow direction F, and is physically connected, for example by welding, along an upper edge to downstream surface 21b. Lower reinforcing members 52 serve to further stiffen reinforced melting assembly 10.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles. In some embodiments of the invention, certain features of the invention may be used to advantage without a corresponding use of other features. Accordingly, all such changes and embodiments properly fall within the scope and equivalents of the following claims.

We claim:

1. A reinforced melting assembly for use in an in-line, direct melt system for producing continuous glass filaments directly from unrefined, raw glass-forming materials, said materials defining a flow direction, the reinforced melting assembly comprising;
an electrically conductive, transverse melting member having perforations there through and having opposed longitudinal flanges adapted for connection to a power supply, said transverse melting member disposed in use transverse to said flow direction upstream of a bushing and having an upstream surface and a downstream surface; and
a plurality of electrically conductive, melting and reinforcement members extending across a width of the upstream surface at spaced intervals between said flanges, each melting and reinforcement member lying in a plane parallel to said flow direction, said melting and reinforcing members being electrically and physically connected to said transverse melting member.

2. The reinforced melting assembly of claim 1, wherein said melting and reinforcement members include outer melting and reinforcement members disposed at ends of said transverse melting member.

3. The reinforced melting assembly of claim 2, wherein said outer melting and reinforcement members have upper edges that lie above said flanges.

4. The reinforced melting assembly of claim 1, wherein said melting and reinforcement members include inner melting and reinforcement members having upper edges that lie below said flanges.

5. The reinforced melting assembly of claim 1, wherein said transverse melting member has a trapezoidal cross-section.

6. The reinforced melting assembly of claim 1, wherein said transverse melting member further comprises a base plate longitudinally connected to said flanges by outwardly diverging sidewalls, said base plate and said diverging sidewalls having perforations there through.

7. The reinforced melting assembly of claim 6, wherein said melting and reinforcement members include outer melting and reinforcement members disposed at ends of said base plate.

8. The reinforced melting assembly of claim 7, wherein said outer melting and reinforcement members have a six-sided profile in the form of two trapezoidal members joined along their longest sides.

9. The reinforced melting assembly of claim 6, wherein a portion of said outwardly diverging sidewalls adjacent said flanges comprise a crumple zone free of perforations, and wherein the reinforced melting assembly further comprises a plurality of key hole slots extending transversely across said flanges to said crumple zone.

10. The reinforced melting assembly of claim 1, further comprising a plurality of reinforcing members extending along a downstream surface of said transverse melting member.

11. The reinforced melting assembly of claim 1, wherein said transverse melting member has a catenary cross-section.

12. An in-line system for producing continuous glass filaments directly from unrefined glass batch, said batch defining a flow direction, the system comprising:
a furnace having opposed end walls, opposed side walls longer than said end walls, an inlet for receiving said unrefined glass batch, and an electrically conductive bushing having a plurality of outlets for discharging said filaments;
a first power supply electrically connected to said bushing for heating said bushing to a first temperature;
a reinforced melting assembly disposed transverse to said flow direction upstream of said bushing, said reinforced melting assembly comprising,
an electrically conductive, transverse melting member having perforations there through and having opposed longitudinal flanges adapted for connection to a second power supply along said side walls, said transverse melting member having an upstream surface and a downstream surface; and
a plurality of electrically conductive, melting and reinforcement members extending across the width of the upstream surface of said transverse melting member at spaced intervals, each melting and reinforcement member lying in a plane parallel to said flow direction, said melting and reinforcing members being electrically and physically connected to said transverse melting member; and
a second power supply electrically separate from said first power supply, for electrically heating said reinforced melting assembly to a second temperature.

13. The system of claim 12, wherein said melting and reinforcing member is operational at a temperature higher than said bushing.

14. The system of claim 13, wherein said melting and reinforcing member is operational at a temperature about 400 degrees F. higher than said bushing.

15. The system of claim 14, wherein said melting and reinforcing member is operational at a temperature of about 3050 degrees F. and said bushing is operational at a temperature of about 2650 degrees F.

16. The system of claim 12, wherein said transverse melting member further comprises a base plate longitudinally connected to said flanges by outwardly diverging sidewalls, said base plate and said diverging sidewalls having perforations there through, and wherein said melting and reinforcement members include inner melting and reinforcement members having upper edges that lie below said flanges and include outer melting and reinforcement members disposed at ends of said base plate and having upper edges that lie above said flanges.

17. The system of claim 16, wherein a portion of said outwardly diverging sidewalls adjacent said flanges comprise a crumple zone free of perforations.

18. An in-line method for producing continuous glass filaments directly from glass batch, said batch defining a flow direction, the method comprising the steps of:
supplying glass batch to a furnace;
providing a reinforced melting assembly in said furnace, said reinforced melting assembly comprises an electrically conductive, transverse melting member disposed transverse to said flow direction upstream of a bushing, said transverse melting member having perforations for flow there through and having opposed longitudinal flanges adapted for connection to a power supply, said reinforced melting assembly further comprising a plurality of electrically conductive, melting and reinforcement members extending across a width of an upstream surface of said transverse melting member at spaced intervals, each melting and reinforcement member lying in a plane parallel to said flow direction, said melting and reinforcing members being electrically and physically connected to said transverse melting member;
forming a melting and refining zone that extends up to a height of said melting and reinforcement members by electrically heating said transverse melting member and said melting and reinforcement members;
converting said glass batch into a heat-softened material in said melting and refining zone; and
forming said heat-softened material into continuous glass filaments by drawing said heat-softened material through openings in said bushing.

19. The method of claim 18, further comprising the steps of heating said bushing to a first temperature by electrically connecting said bushing to a first power supply and heating said reinforced melting assembly to a second temperature by electrically connecting said reinforced melting assembly to a second power supply electrically separate from said first power supply.

20. The method of claim 18, further comprising the step of reducing bypass flow of material around said reinforced melting assembly by providing melting and reinforcing members along ends of said transverse melting member.

21. The method of claim 18, further comprising the step of forming a transverse melting member by bending one or more sheets to form a base plate connected between longitudinal flanges by diverging sidewalls.
